(19) United States
(12) Patent Application Publication
(10) Pub. No.: US 2003/0044063 A1
(43) Pub. Date: Mar. 6, 2003

(54) Method for processing digital photographic image data that includes a method for the automatic detection of red-eye defects

(76) Inventors: Guenter Meckes, Munich (DE); Tobias Damm, Munich (DE); Manfred Fuersich, Taufkirchen (DE); Knut Oberhardt, Foeching (DE); Klaus Hartmann, Schondorf (DE); Thomas Schuhrke, Munich (DE); Gudrun Taresch, Munich (DE)

Correspondence Address: Karl F. Milde, Jr., Esq., MILDE & HOFFBERG, L.L.P., Suite 460, 10 Bank Street, White Plains, NY, 10606, US

(21) Appl. No.: 10/192,713

(22) Filed: Jul. 9, 2002

(30) Foreign Application Priority Data
Sep. 3, 2001 (EP) 01121103.4

(51) Int. Cl. G06K 9/00; G06K 9/46

(52) U.S. Cl. 382/165; 382/190; 382/199; 382/203

(57) ABSTRACT

A method for processing digital photographic image data includes a method for the automatic detection of red-eye defects. Before the image data are subjected to an elaborate process for the detection of red-eye defects, exclusion criteria are analyzed in the course of an exclusion process, whereby the criteria provide the information to definitively rule out the occurrence of red-eye defects. The red-eye detection process is not carried out if such exclusion criteria are fulfilled.

### BACKGROUND OF THE INVENTION

The invention relates to a method for processing digital photographic image data which includes the automatic detection of red-eye defects.

Such methods are known from various electronic applications that deal with digital image processing.

Semi-automatic programs exists, for example, for the detection of red eyes, where the user has to mark the region that contains the red eyes on an image presented by a PC. Within these marked areas the red error spots are then automatically detected and a corrective color that resembles the brightness of the eye is assigned and the correction is carried out automatically.

However, such methods are not suited for automatic photographic developing and printing machines, where many images have to be processed very quickly in succession, leaving no time to have each individual image viewed, and if necessary marked by the user.

For this reason, fully automatic methods have been developed for the use in automatic photographic developing and printing machines.

For example, EP 0,961,225 describes a program comprised of several steps for detecting red eyes in digital images. Initially, areas exhibiting skin tones are detected. In the next step, ellipses are fit into these detected regions with skin tones. Only those regions, where such ellipse areas can be fitted, will then be considered candidate regions for red eyes. Two red eye candidates are than sought within these regions, and their distance—as soon as determined—is compared to the distance of eyes. The areas around the red eye candidates that have been detected as potential eyes are now compared to eye templates to verify that they are indeed eyes. If these last two criteria are met as well, it is assumed that red eyes have been found. These red eyes are then corrected.

The disadvantage of the known automatic red-eye detection methods is that they analyze all images to be copied for red-eye defects, which is very time-consuming. This significantly reduces the performance of photographic developing and printing machines that use such methods.

### SUMMARY OF THE INVENTION

It is, therefore, a principal objective of the present invention to develop a method for processing digital photographic image data which includes a method for the automatic detection of red eyes that allows for very quick processing of the images such that the performance of the photographic developing and printing machines is not reduced.

This objective, as well as other objectives which will become apparent from the discussion that follows, are achieved, in accordance with the present invention, by analyzing at least one exclusion criterion, prior to the application of the method for the detection of red-eye defects, wherein the exclusion criterion possibly includes information which, if present, definitely rules out the occurrence of red-eye defects. If the occurrence of red-eye defects is definitely ruled out, the method for the detection of red-eye defects is terminated.

According to the invention, an exclusion method is inserted in the beginning process of the method for detecting red-eye defects, where the beginning process serves the purpose of sorting out images that definitely do not exhibit red-eye defects. This is accomplished by analyzing the image data for exclusion criteria that, if they are present, one can assume that either no person is in the picture, or that the light of the camera flash was reliably not the dominant light source when the picture was taken, or that a flash was not used at all. Since there are reliably no red-eye defects in images where either no eyes are present or no flash had been used that could be reflected in the fundus of the eye, it would be superfluous to subject such image data to a process for detecting red-eye defects. Much computing time can be saved by sorting out such images prior to the application of the red-eye detection method.

It is particularly advantageous to analyze exclusion criteria already included in the auxiliary film data that have been saved at the time when the picture was taken or that are present on the film. These are quickly identified and can be easily analyzed without the necessity to analyze the actual image content data. Excluding images based on auxiliary image data prior to the detection process for red-eye defects is unambiguous and most efficient and can save much computing time.

With some films, using the auxiliary image data, one can determine the absence of a flash when shooting a picture based on the flash marker set by the camera when taking the picture. APS or digital cameras are capable of setting such markers that indicate whether a flash has been used or not. If a flash marker has been set that signifies that no flash has been used when taking the picture, it can be assumed with great reliability that no red-eye defects occur in the image. All images with such a flash marker are sorted out before the application of the method for detecting red-eye defects; the defect detection step is skipped during processing, and additional image processing methods can be started immediately after the exclusion.

Another exclusion criterion that determines, based on the auxiliary film data, immediately that no red-eye defects can be found in the image is the presence of a black and white film. This fact can be read from the DX code of the film. Although similar light reflections can occur within the eyes on black and white films, a red-eye defect program that analyzes the defects in a typical manner by including criteria such as skin tone or red area detection, etc. will never be able to detect such light reflections. For this reason, it does not make sense to apply the red-eye defect detection program to black and white images. This would only be a waste of computing time. Thus, with the common methods, it is prudent to exclude black and white images from the outset and not to search for red-eye defects, and instead start immediately with the other image processing methods. However, if a method for detecting red-eye defects were used that only operates with gray scale density profiles, it would be possible to recognize such light reflections also in black and white images, and it would not be useful to use this exclusion criterion. However, as a rule, this is not the case.

An additional advantageous method is to analyze exclusion criteria using an image data set that is reduced in comparison to the image data set that is used in the method for detecting red-eye defects. These reduced data sets are often sufficient for the analysis of exclusion criteria and the analysis, can be carried out much faster than the analysis of the complete data set. A reduced data set may be a data set with a lower resolution of the image data, for example.

The analysis to determine whether a flash has been used can be carried out using low-resolution data as well. Typically, when scanning photographic presentations, a pre-scan is performed prior to the actual scanning that provides the image data. This pre-scan determines a selection of the image data in a much lower resolution. Essentially, these pre-scan data are used to optimally set the sensitivity of the recording sensor for the main scan. However, they also lend themselves to the use in the exclusion process.

These low-resolution data are advantageous for the analysis of the exclusion criteria because their analysis does not require much time due to the small data set. If only one scan of the images is carried out or if only high-resolution digital data are present, it is advantageous to combine these data to low-resolution data for the purpose of checking the exclusion criteria. This can be done using an image raster, mean value generation or a pixel selection.

Providing a gray scale image of the image data can also carry out data reduction for the exclusion process. Here, a significantly reduced number of gray scales, when compared to the print stage, may be sufficient to analyze exclusion criteria. And again, the data set is significantly reduced in comparison to color images or multi-color images. Such a gray scale image can preferably also be generated by rastering, where a coarse raster may be selected, which in addition to the color gradation reduces the image resolution as well.

For exclusion criteria, where only an assertion can be made that they are true with a certain probability or not, but where a one hundred percent determination is not possible, it is advantageous to analyze several of these exclusion criteria independently and to combine the results for the individual exclusion criteria to an overall exclusion evaluation. This combining process can be carried out using a weighting of the individual criteria or by applying a neural network.

It is particularly advantageous to analyze several exclusion criteria simultaneously. A parallel analysis can save much computing time.

A particularly significant criterion that—as already mentioned—serves as an exclusion criterion is the use of a flash when taking pictures. This is a very reliable criterion, since red-eye defects occur only in images, when taking a picture of a person and the flash is reflected in the fundus (background) of the eye. However, the absence of a flash in an image can only be determined directly if the camera sets so-called “flash markers” when taking the picture.

With the majority of images having no such flash markers set, it can be concluded only indirectly, whether a flash picture is present or not. This can be determined, for example, by using an image analysis. In such an analysis, one may look for strong shadows of persons on the background, where the outline of the shadow corresponds to that of the outline of the face, but where the area exhibits a different color or image density than the face. As soon as such very dominant hard shadows are present, it can be assumed with great probability that a flash has been used when taking the picture.

An indication that no flash has been used when taking the picture can be made when it is determined that the image is very poor in contrasts. The determination that the image is an artificial light image—that is, an image that exhibits the typical colors of lighting of an incandescent lamp or a fluorescent lamp—also indicates that no, or no dominant flash has been used. The analysis that is carried out to determine whether a flash has been used can also be done based on the low-resolution data.

To increase the reliability of the assertion about the presence of a flash picture or the absence of a flash when the picture has been taken, it is advantageous to check several of the criteria mentioned here and to combine the results obtained when checking the individual criteria to an overall result and an assertion about the use of a flash. To save computing time, it is advantageous here is well to analyze the criteria simultaneously. The evaluation may be carried out using probabilities or a neural network as well.

An additional significant exclusion criterion to be checked for the automatic detection of red-eye defects are adjacent skin tones. Although there will definitely be images that do not exhibit adjacent skin tones yet will have red-eye defects (e.g., when taking a picture of a face covered by a carnival mask), this criterion may be used as an exclusion criterion to limit the pictures that are analyzed for redeye defects if one accepts a few erroneous decisions.

If the analysis of skin tones shall be used as an exclusion criterion, where in their absence red-eye defects are no longer sought, it is also sufficient to use the pre-scan data or corresponding data sets that are reduced in their resolution. If no skin tones appear in these low-resolution data, then reliably no large adjacent skin tone areas are present in the images.

However, it is particularly advantageous to check this criterion along with others in the image data and to include it as one of many criteria into an overall evaluation. This would ensure that red-eye defects could be found even in carnival pictures, in pictures of persons with other skin tones or at a very colorful, dominant lighting, where the skin tones are altered. Although the indication “skin tone” is absent in such pictures, all other analyzed criteria could be determined with such high probability or so reliably that the overall evaluation indicates or suggests the presence of red-eye defects, even with the absence of skin tones. The method described in the aforementioned EP 0,961,225 would, on the other hand, terminate the red-eye detection process due to the absence of skin tones, possibly resulting in an erroneous decision.

However, if skin tones are present in an image, it can be assumed that it is picture of a person, where the presence of red-eye defects are much more probable than in all other images. Thus, this criterion may be weighted more strongly. In particular, adjacent skin tones can be analyzed to see if they meet characteristics of a face—such as its shape and size—since with the probability of it being a face, the probability of there being red-eye defects increases as well. In this case, the criterion may be even more meaningful.

An additional exclusion criterion is a significant fall-off of the Fourier transformed signal of the image data, which points to the absence of any detailed information in the image; that is, a very homogeneous image. Also all other criteria used for the detection of red eyes that can be checked quickly and that reliably provide the exclusion of images without red-eye defects can be used as exclusion criteria. For example, the fact that no red tones or no color tones at all are present in the entire image information may be used as an exclusion criterion.

For a full understanding of the present invention, reference should now be made to the following detailed description of the preferred embodiments of the invention as illustrated in the accompanying drawing.

### BRIEF DESCRIPTION OF THE DRAWING

FIG. 1, comprised of FIGS. 1A, 1B and 1C, is a flowchart of an exemplary embodiment of the method according to the invention.

### DESCRIPTION OF THE PREFERRED EMBODIMENTS

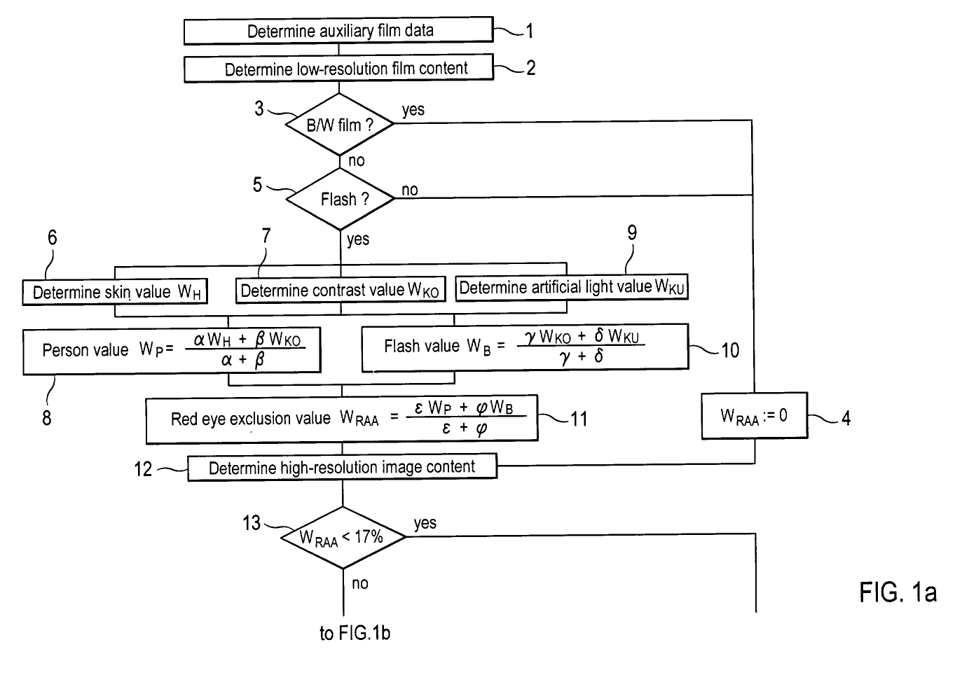

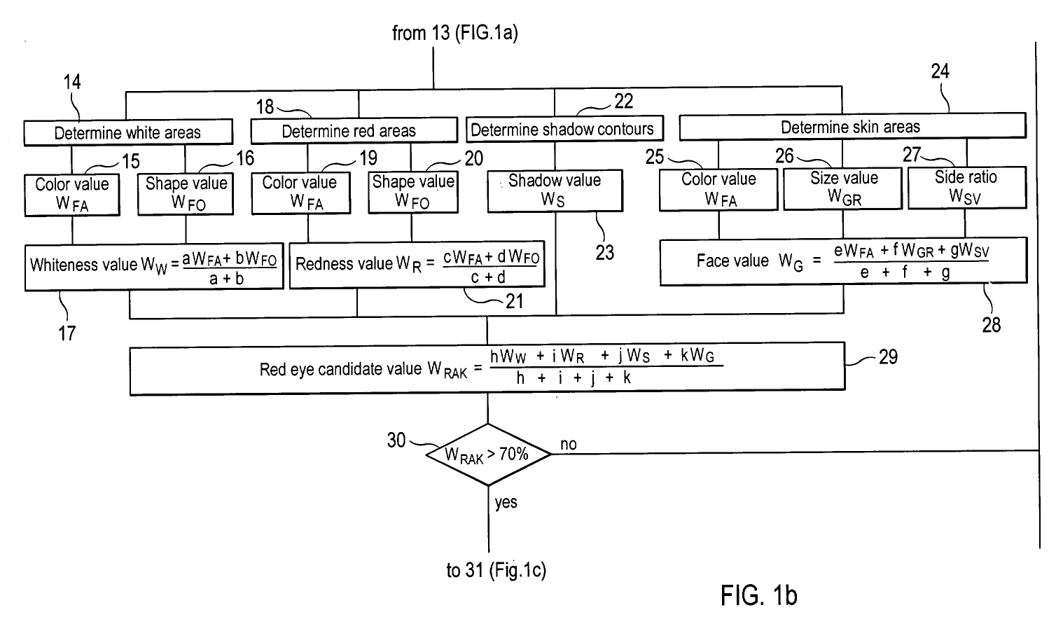

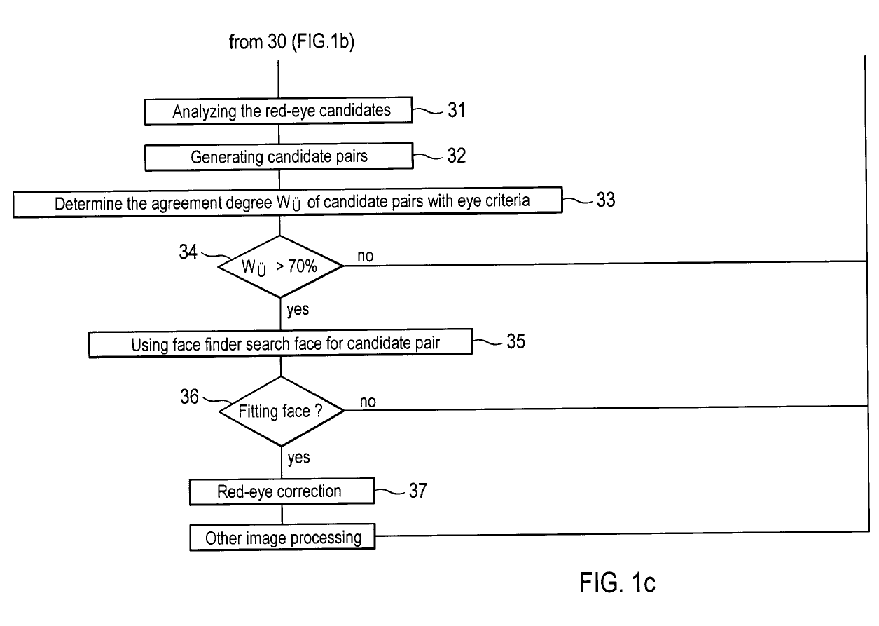

An advantageous exemplary embodiment of the invention will now be explained with reference to the flowchart of FIG. 1.

In order to analyze image data for red-eye defects, the image data must first be established using a scanning device, unless they already exist in a digital format, e.g., when coming from a digital camera. Using a scanner, it is generally advantageous to read out auxiliary film data such as the magnetic strip of an APS film using a low-resolution pre-scan and to determine the image content in a rough raster. Typically CCD lines are used for such pre-scans, where the auxiliary film data are either read out with the same CCD line that is used for the image content or are collected using a separate sensor. The auxiliary film data are determined in a step 1; however, they can also be determined simultaneously with the low-resolution film contents, which would otherwise be determined in a step 2. The low-resolution image data can also be collected in a high-resolution scan, where the high-resolution data set is then combined to a low-resolution data set. Combining the data can be done, for example, by generating a mean value across a certain amount of data or by taking only every x^{th} high-resolution image point for the low-resolution image set. Based on the auxiliary film data, a decision is made in a step 3 or in the first evaluation step, whether the film is a black and white film. If it is a black and white film, the red-eye detection process is terminated, the red-eye exclusion value W_{RAA} is set to Zero in a step 4, the high-resolution image data are determined, unless they are already present from a digital data set, and processing of the high-resolution image data is continued using additional designated image processing methods. The process continues in the same manner if a test step 5 determines that a flash marker is contained in the auxiliary film data that indicates that no flash has been used when taking the picture. As soon as such a flash marker has determined that no flash has been used when taking the picture, no red-eye defects can be present in the image data set. Thus, here too the red-eye exclusion value W_{RAA} is set to Zero, the high-resolution image data are determined, and other, additional image processing methods are started. Using the exclusion criteria “black and white film” and “no flash when taking picture”, which can be determined from the auxiliary film data, images that reliably cannot exhibit red-eye defects are excluded from the red-eye detection process. Much computing time can be saved by using such exclusion criteria because the subsequent elaborate red-eye detection method no longer needs to be applied to the excluded images.

Additional exclusion criteria that can be derived from the low-resolution image content are analyzed in the subsequent steps. For example, in a step 6, the skin value is determined from the low-resolution image data of the remaining images. To this end, skin tones that are an indication that persons are shown in the photo are sought in the image data using a very rough raster. The contrast value determined in a step 7 is an additional indication for persons in the photo. With an image that is very low in contrasts, it can also be assumed that no persons have been photographed. It is advantageous to combine the skin value and the contrast value to a person value in a step 8. It is useful to carry out a weighting of the exclusion values “skin value” and “contrast value”. For example, the skin value may have a greater weight than the contrast value in determining whether persons are present in the image. The correct weighting can be determined using several images, or it can be found by processing the values in a neural network. The contrast value is combined with an artificial light value determined in step 9, which provides information whether artificial lighting—such as an incandescent lamp or a fluorescent lamp—is dominant in the image in order to obtain information whether the recording of the image data has been dominated by a camera flash. Contrast value and artificial light value generate a flash value in step 10.

If the person value and the flash value are very low, it can be assumed that no person is in the image and that no flash photo has been taken. Thus, the occurrence of red-eye defects in the image can be excluded. To this end, a red-eye exclusion value W_{RAA} is generated from the person value and the flash value in a step 11. It is not mandatory that the exclusion criteria “person value” and “flash value” be combined to a single exclusion value. They can also be viewed as separate exclusion criteria. Furthermore, it is imaginable to check other exclusion criteria that red-eye defects cannot be present in the image data.

When selecting the exclusion criteria, it is important to observe that checking these criteria must be possible based on low-resolution image data, because computing time can only be saved in a meaningful manner if very few image data can be analyzed very quickly to determine whether a red-eye detection method shall be applied at all or if such defects can be excluded from the outset. If checking the exclusion criteria were to be carried out using the high-resolution image data, the savings in computing time would not be sufficient to warrant checking additional criteria prior to the defect detection process. In this case, it would be more prudent to carry out a red-eye detection process for all photos. However, if the low-resolution image contents are used to check the exclusion criteria, the analysis can be done very quickly such that much computing time is saved, because the elaborate red-eye detection process based on the high-resolution data does not need to be carried out for each image.

If the image data are not yet present in digital format, the data of the high-resolution image content need now be determined from all images in a step 12. With photographic films, this is typically accomplished by scanning, using a high-resolution area CCD. However, it is also possible to use CCD lines or corresponding other sensors suitable for this purpose.

If the pre-analysis has determined that the red-eye exclusion value is very low, it can be assumed that no red-eye defects can be present in the image. The other image processing methods such as sharpening or contrast editing will be started without carrying out a red-eye detection process for the respective image. However, if in step 13 it is determined that red-eye defects cannot be excluded from the outset, the high-resolution image data will be analyzed to determine, whether certain prerequisites or indications for the presence of red-eye defects are at hand and the actual defect detection process will start.

It is advantageous that these prerequisites and/or indications are checked independent of one another. To save computing time, it is particularly advantageous to analyze them simultaneously. For example, in a step 14, the high-resolution image data are analyzed to determine, whether white areas can be found in them. A color value W_{FA} is determined for these white areas in a step 15, where said color value is a measure for how pure white these white areas are. In addition, a shape value W_{FO} is determined in step 16 that indicates, whether these found white areas can approximately correspond to the shape of a photographed eyeball or a light reflection in an eye or not. Color value and shape value are combined to a whiteness value in step 17, whereby a weighting of these values may be carried out as well. Simultaneously, red areas are determined in a step 18 that are assigned color and shape values as well in steps 19 and 20, respectively. From these, the redness value is determined in a step 21. The shape value for red areas refers to the question, whether the shape of the found red area corresponds approximately to the shape of a red-eye defect.

An additional, simultaneously carried out step 22 determines shadow outlines in the image data. This can be done, for example, by searching for parallel running contour lines whereby one of these lines is bright and the other is dark. Such dual contour lines are an indication that a light source is throwing a shadow. If the brightness/darkness difference is particularly great, it can be assumed that the light source producing the shadow was the flash of a camera. In this manner, the shadow value reflecting this fact and determined in a step 23 provides information, whether the probability for a flash is high or not.

The image data are analyzed for the occurrence of skin areas in an additional step 24. If skin areas are found, a color value—that is, a value that provides information how close the color of the skin area is to a skin tone color—is determined from these areas in a step 25. Simultaneously, a size value, which is a measure for the size of the skin area, is determined in a step 26. Also simultaneously, the side ratio, that is, the ratio of the long side of the skin area to its short side, is determined in a step 27. Color value, size value and side ratio are combined to a face value in a step 28, where said face value is a measure to determine how closely the determined skin area resembles a face in color size and shape.

Whiteness value, redness value, shadow value and face value are combined to a red-eye candidate value W_{RAK} in a step 29. It can be assumed that the presence of white areas, red areas, shadow outlines and skin areas in digital images indicates a good probability that the found red areas can be valued as red-eye candidates if their shape supports this assumption. When generating this value for a red-eye candidate, other conditions for the correlation of whiteness value, redness value and face value may be entered as well. For example, a factor may be introduced that provides information, whether the red area and the white area are adjacent to one another or not. It may also be taken into account, whether the red and white areas are inside the determined skin area or are far away from it. These correlation factors can be integrated in the red-eye candidate value. An alternative to the determination of candidate values would be to feed color values, shape values, shadow value, size value, side ratio, etc. together with the correlation factors into a neural network and to obtain the red-eye candidate value from it.

Finally, the obtained red-eye candidate value is compared to a threshold in a step 30. If the value exceeds the threshold, it is assumed that red-eye candidates are present in the image. A step 31 then investigates, whether these red-eye candidates can indeed be red-eye defects. In this step, the red-eye candidates and their surroundings can, for example, be compared to the density profile of actual eyes in order to conclude, based on similarities, that the red-eye candidates are indeed located inside a photographed eye.

An additional option for analyzing the red-eye candidates is to search for two corresponding candidates with almost identical properties that belong to a pair of eyes. This can be done in a subsequent step 32 or as an alternative to step 31 or simultaneous to it. If this verification step is selected, only red-eye defects in faces photographed from the front can be detected. Profile shots with only one red eye will not be detected. However, since red-eye defects generally occur in frontal pictures, this error may be accepted to save computing time. If the criteria recommended in steps 31 and 32 are used for the analysis, a step 33 determines an agreement degree of the found candidate pairs with eye criteria. In step 34, the agreement degree is compared to a threshold in order to decide, whether the red-eye candidates are with a great degree of probability red-eye defects or not. If there is no great degree of agreement, it must be assumed that some other red image contents were found that are not to be corrected. In this case, processing of the image continues using other image processing algorithms without carrying out a red-eye correction.

However, if the degree of agreement of the candidates with eye criteria is relatively great, a face recognition process is applied to the digital image data in a subsequent step 35, where a face fitting to the candidate pair shall be sought. Building a pair from the candidates offers the advantage that the orientation of the possible face is already specified. The disadvantage is—as has already been mentioned—that the red-eye defects are not detected in profile photographs. If this error cannot be accepted, it is also possible to start a face recognition process for each red-eye candidate and to search for a potential face that fits this candidate. This requires more computing time but leads to a reliable result. If no face is found in a step 36 that fits the red-eye candidates, it must be assumed that the red-eye candidates are not defects, the red-eye correction process will not be applied and instead, other image processing algorithms are started. However, if a face can be determined that fits the red-eye candidates, it can be assumed that the red-eye candidates are indeed defects, which will be corrected using a typical correction process in a correction step 37. Methods using density progressions such as those commonly used in the field of real-time people monitoring or identity control may be used as a suitable face recognition method for the analysis of red-eye candidates. As a matter of principle, however, it is also possible to use simpler methods such as skin tone recognition and ellipses fits. However, these are more prone to errors.

There has thus been shown and described a novel method for processing digital photographic image data, that includes a method for the automatic detection of red-eye defects, which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In a method for processing digital photographic image data, where a method for the automatic detection of red-eye defects is applied to the image data, the improvement comprising the step of analyzing at least one exclusion criterion prior to the application of the method for the detection of red-eye defects, said exclusion criterion possibly including information which, if present, definitively rules out the occurrence of red-eye defects; and terminating the method for the detection of red-eye defects if said information is present.

2. Method as set forth in claim 1, wherein said at least one exclusion criterion is analyzed using auxiliary film data.

3. Method as set forth in claim 1, wherein the presence of flash markers in the recording data is an exclusion criterion, and wherein said exclusion criterion is analyzed to determine whether no flash was used when creating the photographic image data.

4. Method as set forth in claim 1, wherein the presence of a black and white photograph is an exclusion criterion.

5. Method as set forth in claim 1, wherein said analysis of at least one exclusion criterion is operative on a reduced image data set as compared to a data set used for detecting red-eye defects.

6. Method as set forth in claim 5, wherein said reduced image data set is a low-resolution image data set.

7. Method as set forth in claim 6, further comprising the step of pre-scanning, in low resolution, a film containing the image data.

8. Method as set forth in claim 6, wherein said image data are present in digital form and further comprising the step of reducing the resolution of said image data.

9. Method as set forth in claim 5, wherein the resolution reduction step includes the step of generating a gray scale image of the image data.

10. Method as set forth in claim 1, wherein a plurality of exclusion criteria are analyzed independently of one another.

11. Method as set forth in claim 10, wherein a plurality of exclusion criterion are analyzed simultaneously with one another.

12. Method as set forth in claim 10, wherein the results of the analyses of a plurality of exclusion criterion are combined to provide an overall evaluation.

13. Method as set forth in claim 1, wherein the absence of a flash photograph is an exclusion criterion, and wherein the step of analyzing the exclusion criterion includes determining whether the dominant light source for a photographic image is other than a camera flash.

14. Method as set forth in claim 13, wherein said analysis step includes the step of detecting an artificial light photograph, thereby to determine that an artificial light source was the dominant light source when the photograph was created.

15. Method as set forth in claim 13, wherein said analyzing step includes the step of detecting a photograph low in contrast, thereby to determine that no flash has been used.

16. Method as set forth in claim 1, wherein a significant drop of Fourier transformed signals of the image data is an exclusion criterion.

17. Method as set forth in claim 1, wherein the absence of large skin tone areas is an exclusion criterion.
